(19) United States
(12) Patent Application Publication
(10) Pub. No.: US 2007/0241490 A1
(43) Pub. Date: Oct. 18, 2007

(54) PEN VISE HAVING A MOUNTING PLATFORM ADJUSTABLE IN BOTH X AND Y DIRECTIONS

(76) Inventor: Douglas A. Myers, Woodland Hills, UT (US)

Correspondence Address: Angus C. Fox, III, 4093 N. Imperial Way, Provo, UT, 84604-5386, US

(21) Appl. No.: 11/735,434

(22) Filed: Apr. 13, 2007

Related U.S. Application Data
(60) Provisional application No. 60/792,197, filed on Apr. 13, 2006.

(51) Int. Cl. B25B 1/20

(52) U.S. Cl. 269/43

(57) ABSTRACT

A pen vise includes a jaw assembly having parallel front and rear grooved bars which are drawn together by two clamping bolts located at opposite ends of the jaw assembly in order to secure multiple workpieces between the grooved bars. The rear grooved bar has a longitudinal projection of dovetail cross section that slideably engages a groove of dovetail cross section on a base member of the vise, so that the jaw assembly can be moved in an X direction to position each of the workpieces beneath a machining axis. The jaw assembly is disposed between front and back walls of the base member. A securing bolt engages a threaded aperture in the front wall and both indexes and clamps the jaw assembly against the rear wall.

This application has a priority date based on the filing of provisional patent application 60/792,197, which was filed on Apr. 13, 2006.

### FIELD OF THE INVENTION

This invention relates, generally, to bench-mounted vises and, more particularly, to vices used in the manufacture of custom pens and other writing instruments.

### BACKGROUND OF THE INVENTION

During the past decade, the manufacture of custom pens and mechanical pencils has become a popular and lucrative hobby. Typically, pen enthusiasts purchase metal hardware and small blanks of exotic woods. The blanks are center drilled in a special vise designed for the task, then individually placed on a turning shaft between collets. The shaft is then inserted in a lathe spindle, and after the blank is tightened between the collets, the blank is turned on the lathe to create a pen barrel or cap having a desired shape. After staining and/or lacquering, metal pieces are pressed into the turned barrel and cap wood pieces to create a finished pen or mechanical pencil body.

Most hobbyist fabricators of custom writing instruments simultaneously craft small batches of writing instruments. What is needed is a new pen vise that facilitates the simultaneous fabrication of multiple pens and that lends a new degree of precision to axial drilling steps.

### SUMMARY OF THE INVENTION

The pen vise of the present invention incorporates a jaw assembly that secures multiple workpieces for drilling and other machining. The jaw assembly, which comprise parallel front and rear grooved bars, are clampable together by means of a bolt at each end of the assembly, each bolt having a hand tightenable knob. The rear grooved bar is equipped with a longitudinal projection of dovetail cross section that slides in a mating groove in the base of the vise that is also of dovetail cross section. This feature allows the jaw assembly to be shifted in an X direction so that each of the multiple workpieces can be sequentially drilled. The front grooved bar has indexing dimples that mate with a nipple on a button that is secured to the end of a center bolt that threadably engages a threaded aperture in a vertical front wall that projects from the base. The center bolt serves to clamp the jaw assembly against a vertical rear wall that also projects from the base, in addition to indexing the jaw assembly for each workpiece location of the jaw assembly. A first embodiment base is adjustable only in an X direction by means of a slotted ear on each side of the base, through which a securing threaded fastener, is used to secure the base to a table, bench or workstand. A second embodiment base has upper and lower portions that are slidably coupled with at least one projection of dovetail cross section that mates with a groove that is also of dovetail cross section. This arrangement of the two-part base enables the vise to also be adjusted in a Y direction, thereby facilitating alignment of the center of each workpiece with a drilling or machining axis. Set screws are employed to secure the upper and lower portions of the base together when a desired positioning is achieved. The set screws are preferably made of a material that will not gall the material from which the base is made. For example, if the upper and lower base portions are made of an iron alloy, such as cast iron, mild steel or stainless steel, then brass set screws will not gall the base metal. Likewise, if the upper and lower base portions are made of an alloy of aluminum or magnesium, then nylon set screws can be used.

### BRIEF DESCRIPTION OF THE DRAWINGS

FIG. 1 is an isometric view of an assembled pen vise which incorporates a first embodiment base that is adjustable in an X direction;

FIG. 2 is an isometric view of the center bolt;

FIG. 3 is an isometric view of an assembled first embodiment base;

FIG. 4 is an exploded view of the first embodiment base;

FIG. 5 is an exploded view of a second embodiment base adjustable in both X and Y directions;

FIG. 6 is an exploded view of a pen vise which incorporates the second embodiment base of FIG. 4;

FIG. 7 is an isometric view of an assembled pen vise which incorporates the second embodiment base;

FIG. 8 is an isometric front/top/right-side view of the outer jaw;

FIG. 9 is an isometric rear/top/left-side view of the outer jaw;

FIG. 10 is an isometric front/top/right-side view of the inner jaw; and

FIG. 11 is an isometric rear/top/left-side view of the inner jaw.

### PREFERRED EMBODIMENT OF THE INVENTION

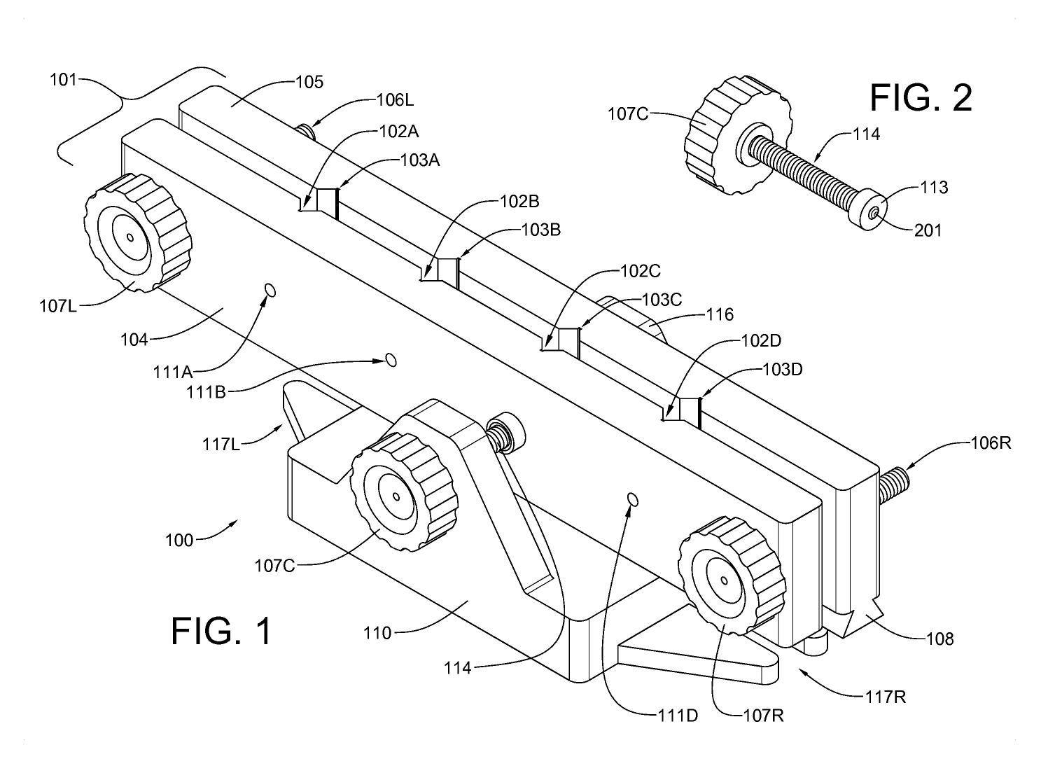

The new pen vise will now be described in greater detail and with reference to the included drawing FIGS. 1 through 11. It should be understood that the items may not necessarily be drawn to scale, although such was the intention.

Referring now to FIG. 1, the pen vise 100 of the present invention incorporates a jaw assembly 101 that secures multiple cylindrical workpieces for drilling and other machining between pairs of opposed vertically-oriented grooves 102A/103A, 102B/103B, 102C/103C and 102D/103D of V-shaped cross section. One groove of each pair (102A, 102B, 102C, and 102D) is located on a front clamping bar 104, while the other groove of each pair 103A, 103B, 103C and 103D are located on a rear clamping bar 105. Clamping bars 104 and 105 are parallel to one another and are clampable together by means of a clamping bolt 106L and 106R at each end of the jaw assembly 101, each bolt having a hand tightenable knob 107L and 107R, respectively. The rear clamping bar 105 is equipped with a longitudinal projection 108 of dovetail cross section that slides in a mating dovetail groove 109 (not shown in this view) cut in the base 110 of the vise 100. This feature allows the jaw assembly 101 to be shifted in an X direction so that each of the multiple workpieces secured between the opposed grooves can be sequentially drilled. The front clamping bar 104 has indexing dimples 111A, 111B, 111C (not shown in this view) and 111D that individually engage a nipple (not shown in this view) that is centered on a button 113 that is rotatably secured to the end of a center bolt 114 that threadably engages a threaded aperture (not visible in this view) in a vertical front wall 115 that projects from the base 110. The center bolt 114, which also has a hand tightenable knob 107C, serves to clamp the jaw assembly 101 against a vertical rear wall 116 that also projects from the base 110, in addition to indexing the jaw assembly 101 for each workpiece secured therein. A first embodiment base 110 is adjustable only in an X direction by means of a slotted ear 117L and 117R on each side of the base, through which a securing threaded fastener (not shown), is used to secure the base to a table, bench or workstand.

Referring now to FIG. 2, the center bolt 114 and button 113 are shown separately in this view. The nipple 201 located in the center of the button 113 is clearly visible in this view.

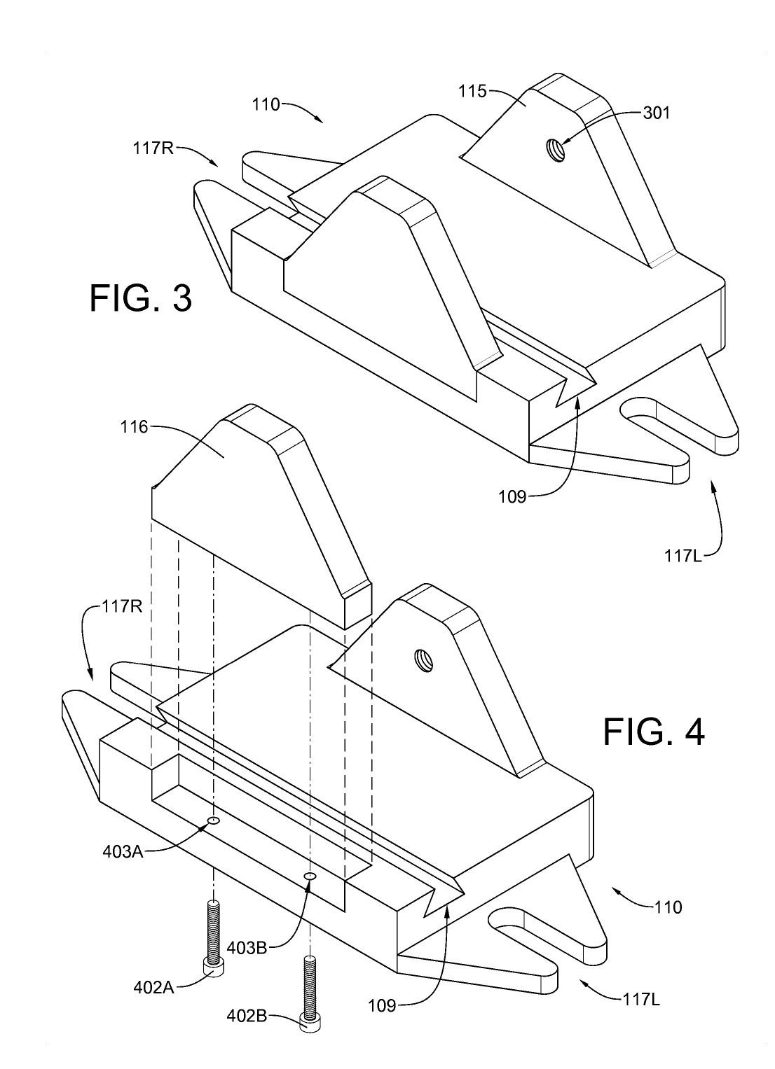

Referring now to FIG. 3, the base 110 is shown separately in this view. The threaded aperture 301 in the front vertical wall 115 is visible in this view. The dovetail groove 109 in the base 110 is more fully visible, as are the slotted ears 117L and 117R.

Referring now to FIG. 4, it will be noted that the rear wall 116 that projects from the base 110 is secured within a recess 401 cut in the base by a pair of socket-head screws 402A and 402B that pass through holes 403A and 403B, respectively that are drilled in the base 110. The rear wall 116 is made removable in order to facilitate machining of the dovetail groove 109 in the base 110.

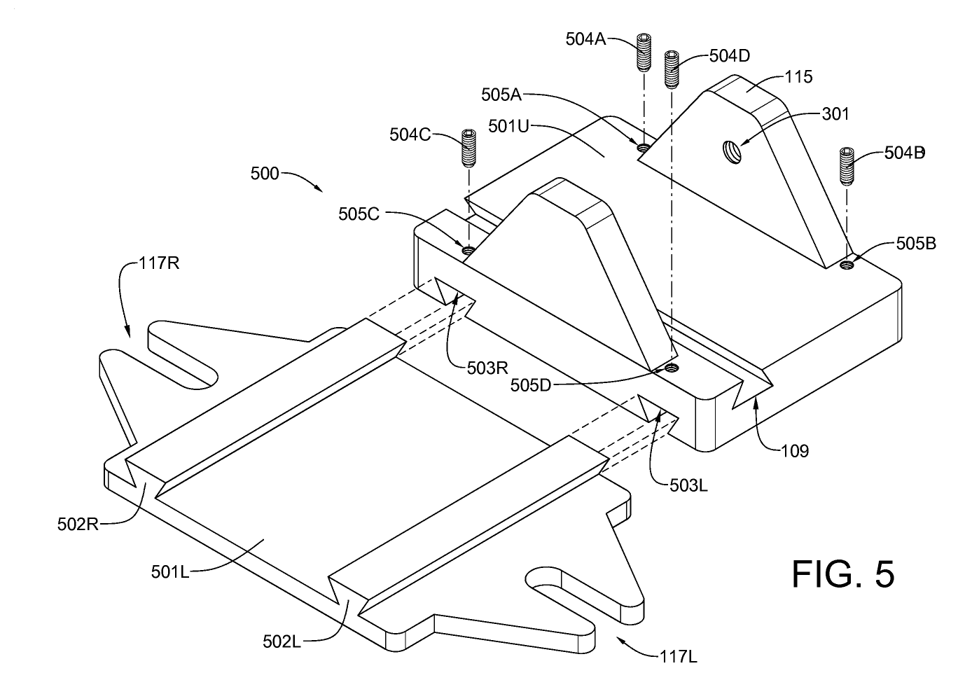

Referring now to FIG. 5, a second embodiment base 500 has upper and lower portions 501U and 501L, respectively, that are slidably coupled with two projections of dovetail cross section 502R and 502L that mate with corresponding groove 503R and 503L that are also of dovetail cross section. This two-part base arrangement enables the vise to also be adjusted in a Y direction, as well as in an X direction, thereby facilitating alignment of the center of each workpiece with a drilling or machining axis. Four socket-head set screws 504A, 504B, 504C and 504D engage threaded holes 505A, 505B, 505C and 505D, respectively in the upper portion 501U and engage the projections 502R and 502L, thereby securing the upper portion 501U and lower portion 501L of the base 500 together when a desired positioning is achieved. The set screws are preferably made of a material that will not gall the material from which the base is made. For example, if the upper and lower base portions 501U and 501L, respectively, are made of an iron alloy, such as cast iron, mild steel or stainless steel, then brass set screws will not gall the base metal. Likewise, if the upper and lower base portions are made of an alloy of aluminum or magnesium, then nylon set screws can be used.

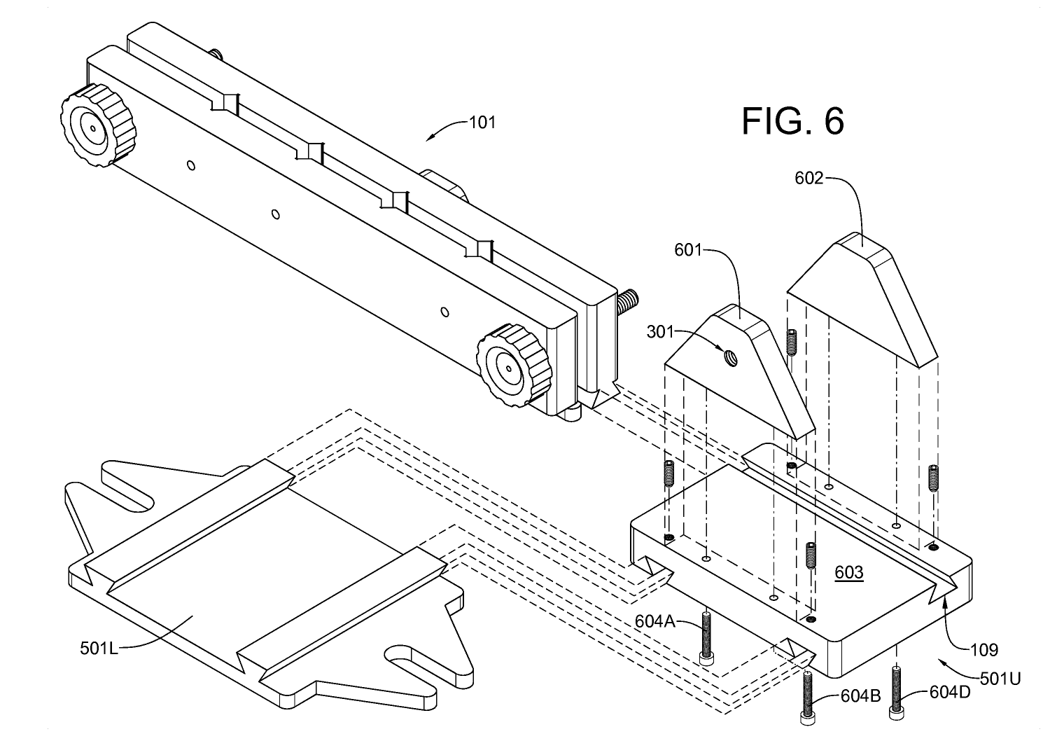

Referring now to FIG. 6, it will be noted that the jaw assembly 101 is identical to that of the vise shown in FIG. 1. It will be also noted that the upper portion 501U of the base 500 has front and rear walls 601 and 602, respectively, which project upwardly therefrom, and which are secured to an upper surface 603 of the upper portion 501U with four socket head screws 604A, 604B, 604C and 604D. Screw 604C is hidden beneath the upper portion 501U. It will be noted that the front wall 601 also has a horizontally-oriented threaded aperture 604, which engages the center bolt 114.

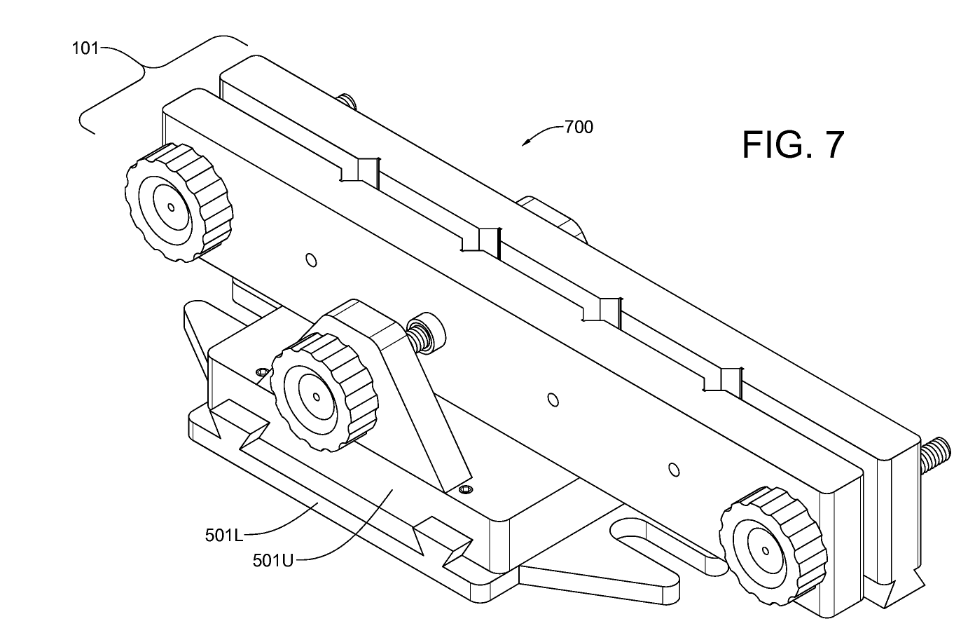

Referring now to FIG. 7, a vise 700 having a base 500 with upper and lower portions 501U and 501L is shown in a completely assembled configuration. Except for the base 500 which is adjustable about X and Y axes in a horizontal plane, this vise is essentially identical to the vise of FIG. 1.

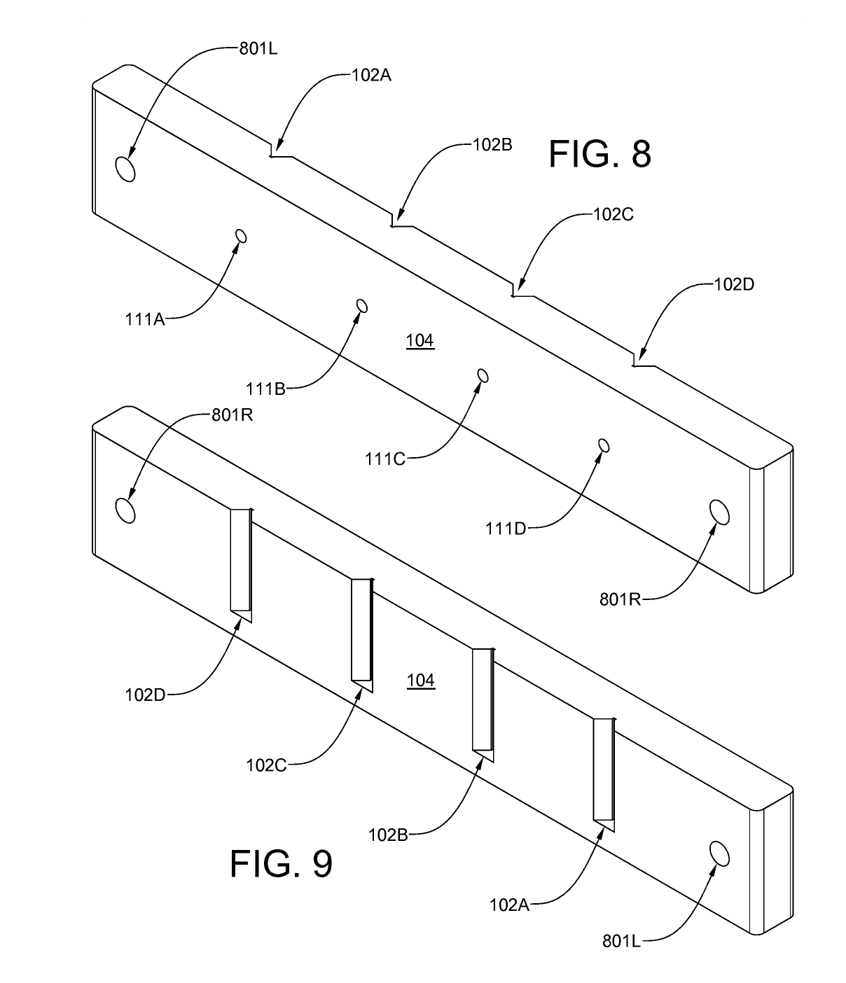

Referring now to FIG. 8, the front clamping bar 104 is shown separately in a front/top/right-side view. The unthreaded apertures 801L and 801R, through which the clamping bolts 106L and 106R are inserted, are visible in this view, as are the indexing dimples 111A, 111B, 111C and 111D, the tops of vertically-oriented grooves 102A, 102B, 102C, and 102D.

Referring now to FIG. 9, this backside view of the front clamping bar 104 completely shows each of the vertically-oriented grooves 102A, 102B, 102C and 102D, as well as the unthreaded apertures 801L and 801R.

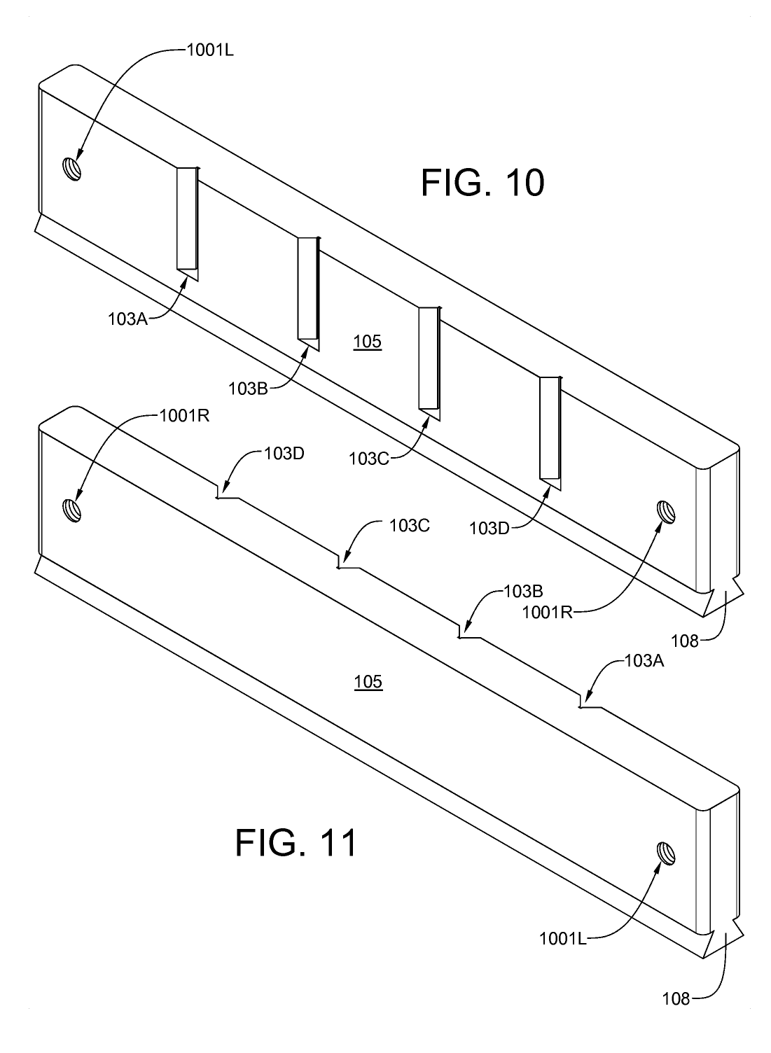

Referring now to FIG. 10, the rear clamping bar 105 is shown separately in a front/top/right-side view. The threaded apertures 1001L and 1001R, which threadably engage the clamping bolts 106L and 106R are visible in this view, as the vertically-oriented grooves 103A, 103B, 103C and 103D, and the longitudinal projection 108 of dovetail cross section over its entire span.

Referring now to FIG. 11, this backside view of the rear clamping bar 105 again shows the threaded apertures 1001L and 1001R and the tops of vertically-oriented grooves 103A, 103B, 103C and 103D.

Although only a single embodiment of the new pen vise is shown and described, it will be obvious to those having ordinary skill in the art that changes and modifications may be made thereto without departing from the scope and the spirit of the invention as hereinafter claimed.

What is claimed is:

1. A pen vise comprising:
a jaw assembly having parallel front and rear grooved bars and a pair of clamping bolts, said grooved bars being clampable together to secure multiple workpieces by means of the clamping bolts, each of which is positioned at one end of the jaw assembly, said rear grooved bar having a longitudinal projection of dovetail cross section, said front grooved bar having multiple indexing dimples on a front surface thereof;
a base having a groove of dovetail cross section that slideably mates with said longitudinal projection, thereby allowing the jaw assembly to be shifted in an X direction so that each of multiple workpieces mounted in the jaw assembly can be sequentially drilled, said base having front and rear walls disposed on either side of the jaw assembly, said front wall having a threaded aperture that received a threaded securing bolt to which a button having an indexing nipple thereon which can engage any of said indexing dimples, said securing bolt also serving to clamp the jaw assembly against the rear wall.
